(19) United States
(12) Patent Application Publication
(10) Pub. No.: US 2026/0332428 A1
(43) Pub. Date: Oct. 22, 2026

(54) SYSTEM AND METHOD FOR IDENTITY VERIFICATION IN TELEPHONY USING DISTRIBUTED LEDGER TRANSACTIONS

(71) Applicants: Ariana Eed, Amersfoort (NL); Matan Friedman, Amsterdam (NL); Yoav Gat, Utrecht (NL); Ron Terman, Amsterdam (NL); Jonathan Kandel, Amsterdam (NL); Amir Dorot, Amstelveen (NL)

(72) Inventors: Ariana Eed, Amersfoort (NL); Matan Friedman, Amsterdam (NL); Yoav Gat, Utrecht (NL); Ron Terman, Amsterdam (NL); Jonathan Kandel, Amsterdam (NL); Amir Dorot, Amstelveen (NL)

(21) Appl. No.: 19/183,960

(22) Filed: Apr. 21, 2025

(51) Int. Cl. H04L 9/32; H04L 9/00; H04L 9/30; H04L 65/1104

(52) U.S. Cl. CPC H04L 9/3236; H04L 9/30; H04L 9/3247; H04L 9/50; H04L 65/1104

(57) ABSTRACT

A system for decentralized, bidirectional identity verification during telephone call setup. After session negotiation, each party generates a cryptographic digest of mutually shared, call-specific data—such as SDP metadata or encryption keys—and includes it in a signed, directed transaction submitted to a distributed ledger. Each transaction is signed using a private key linked to the transaction sender's digital identity, allowing the transaction recipient to verify identity by resolving the sender's public key and locating a matching ledger entry. The published transaction serves as identity proof; comparing the digest locally provides an additional integrity check confirming both parties share the same session context. No identity verification occurs before call establishment, and no raw session data is exposed on-chain. The system operates without centralized authorities or trusted telephony infrastructure, offering asynchronous, tamper-resistant identity verification grounded in publicly auditable distributed ledger transactions.

### CROSS-REFERENCE TO RELATED APPLICATIONS

Not Applicable

### STATEMENT REGARDING FEDERALLY SPONSORED RESEARCH OR DEVELOPMENT

No federally sponsored research or development.

### THE NAMES OF THE PARTIES TO A JOINT RESEARCH AGREEMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

### 1. Field of the Invention

The present invention relates generally to identity verification in telephony networks, and more specifically to mutual authentication using cryptographic transactions on a distributed ledger.

### 2. Description of Related Art Including Information Disclosed Under 37 CFR 1.97 and 1.98

The increasing prevalence of caller identity spoofing, robocalling, and fraudulent telephony practices has highlighted major shortcomings in existing caller authentication mechanisms. Conventional mechanisms often rely on centralized infrastructure, such as caller ID databases or real-time verification servers, which are vulnerable to manipulation, censorship, and trust erosion. Moreover, existing systems typically validate only the caller's identity and do so before the session is fully established—leaving the recipient unverified and the call session itself unauthenticated.

Several systems have attempted to improve caller trustworthiness through centralized or partially decentralized techniques. For example, U.S. Pat. No. 10,122,851 describes an out-of-band authentication system in which a caller digitally signs a token and submits it to a verification server before the call is initiated. While this adds a cryptographic layer to identity assertions, it depends on a central authority and supports only unidirectional verification.

Some newer approaches apply blockchain or decentralized ledger technology. U.S. Pat. No. 11,769,146 outlines a system for publishing caller metadata to a blockchain to verify the identity of a consumer before engaging in a transaction. Similarly, U.S. Patent Application No. 2021/0136196A1 uses decentralized identifiers (DIDs) to associate caller identities with public keys stored on a blockchain, aiming to improve call validation. However, both systems focus on pre-call identity assertion and do not offer mutual, session-specific, or post-call setup identity verification.

U.S. Patent Application No. 20200313901A1 proposes identity authentication for VoIP calls via blockchain, but the process involves querying a centralized blockchain server for public keys—reintroducing a central trust dependency. WO2021173265A1 also leverages DIDs anchored in a distributed ledger for decentralized identity validation, yet it still lacks a mechanism for verifying shared session metadata or enabling post-establishment authentication by both parties.

Recent filings such as US20250106042, US20250106222, and US20250104049 describe systems for identity verification using distributed ledgers. While they advance the state of decentralized identity management, they generally depend on either real-time interaction, centralized trust elements, or assume the presence of a globally trusted framework for public key resolution. They also lack specific support for asynchronous polling, digest comparison of session metadata, or bidirectional validation in live telephony environments.

Other related systems, such as US20250088588 and US20250080647, focus on spam and spoofing mitigation through heuristic call filtering and metadata analysis. While useful for reducing unwanted calls, these approaches do not provide cryptographically verifiable identity guarantees and remain reactive rather than cryptographic in nature.

In summary, while prior art has introduced various identity verification methods—some using centralized servers and others incorporating blockchain or DIDs—these systems suffer from one or more of the following limitations:
Identity is verified before session establishment.
Only the caller's identity is authenticated.
Centralized components are required for resolution or verification.
No mechanism ensures that both parties share the same session context.
Session metadata is not cryptographically summarized or validated.

Accordingly, there remains a need for a system that supports decentralized, privacy-preserving, mutual identity verification after call establishment, without relying on centralized authorities or modifying the telephony signaling path. The present invention addresses this need by enabling devices to independently generate a cryptographic digest of mutually known session metadata—such as Session Description Protocol (SDP) fields—and submit signed, directed transactions to a distributed ledger. Each device can then resolve the digital identity of its counterpart, retrieve the associated transaction, and verify both identity and session consistency using digest comparison—all after the call is fully established.

### DEFINITION OF TERMS

As used herein:
“Wallet Address” refers to a public address associated with a cryptographic key pair and used to send or receive transactions on a distributed ledger. Each wallet address is associated with an asymmetric cryptographic key pair, consisting of a public key (used for verifying digital signatures) and a private key (used for signing transactions). In the context of this invention, a wallet address is resolvable from a digital identity, and is used as the endpoint identifier for directed transactions in the described system.
“Digital identity” refers to any unique identifier associated with a communication party in a telephony or data network environment, including but not limited to telephone numbers, email addresses, domain names, user IDs, decentralized identifiers (DIDs), blockchain-based names (such as ENS names), or any other resolvable identity that can be associated with a cryptographic wallet address. The association between a digital identity and a wallet address is established in a decentralized, publicly accessible, and verifiable manner, without reliance on centralized storage or authorities. This association may be implemented using on-chain mappings, decentralized name resolution systems, decentralized identifier registries, cryptographic proofs, or other decentralized mechanisms. Upon obtaining the digital identity of a party (e.g., from telephony signaling information), each party device is configured to resolve that identity to the corresponding wallet address using these decentralized resolution mechanisms.
“Session Description Protocol (SDP) data” refers to session-specific data explicitly exchanged between parties during telephone call setup. This includes, without limitation, data formats conforming to the Session Description Protocol (SDP) standard, which describes multimedia session parameters such as IP addresses, port numbers, codecs, and session identifiers. The term also encompasses any future standardized or proprietary session description formats that provide functionally equivalent session parameter negotiation between communicating parties.
“Distributed ledger subsystem” refers to any system or network that provides a decentralized, tamper-resistant, and verifiable record of transactions or data entries maintained across multiple nodes, without reliance on a centralized authority. This includes, but is not limited to, blockchain networks, directed acyclic graph (DAG) based ledgers, federated ledgers, permissioned ledgers, and any other decentralized data recording systems. Blockchain networks are a specific example of such distributed ledger subsystems.
“Transaction” refers to a digitally signed data submission that is recorded on a distributed ledger. In the context of this invention, a transaction includes a metadata payload (e.g., a cryptographic digest of call-specific metadata) and is cryptographically signed by the sending device using the private key associated with its wallet address. This signature ensures that the transaction could only have been authored by an entity in control of that private key.
   Each wallet address corresponds to a public key, which may be used to verify the validity of the transaction signature. In blockchain-based implementations, the distributed ledger verifies that the submitted transaction is valid (e.g., signature matches the sending address) before it is accepted into the ledger. Once accepted, the transaction becomes part of the public and tamper-resistant record, accessible for independent verification by counterpart devices.
   Transactions are directed, meaning they explicitly designate a receiving wallet address, which enables the intended recipient to efficiently locate and verify the assertion on the ledger.
   In blockchain-based deployments, transaction submission may incur computational or financial cost—commonly referred to as “gas fees”—which must be paid using the native currency of the blockchain. Therefore, the sender's wallet must hold a sufficient on-chain balance at the time of submission to cover such fees.

The invention is agnostic to the exact mechanism of transaction submission and is compatible with alternative distributed ledger architectures that may not require fees (e.g., permissioned blockchains, DAG-based ledgers, or fee-subsidized systems).

### BRIEF SUMMARY OF THE INVENTION

The present invention provides a system and method for decentralized, real-time, mutual identity verification in packet-switched telephone calls. It applies to VoIP, IMS-based, and future IP telephony environments where call-specific session metadata—such as Session Description Protocol (SDP) fields or encryption keys—is exchanged between endpoints during call setup.

Traditional call verification systems—such as those based on STIR/SHAKEN, centralized databases, or blockchain-based caller assertions—suffer from key limitations: they authenticate only the caller, rely on centralized infrastructure, and perform verification before the call is fully negotiated. These systems do not confirm that both parties share the same session context, nor do they enable independent, trustless identity verification once a session is established.

Objects of the invention include enabling mutual identity verification after session setup, based on the presence of cryptographically signed, directed transactions published to a distributed ledger. These transactions are generated independently by each party and serve as durable, verifiable identity assertions tied to the session context—without modifying the telephony signaling path or exposing sensitive session data.

In the invention, each device generates a cryptographic digest of the shared session metadata and includes it in a signed, directed transaction submitted to a distributed ledger. The transaction, signed using a private key associated with a wallet address, serves as a verifiable identity assertion. The wallet address is publicly resolvable from a claimed digital identity, such as a phone number or decentralized identifier (DID).

After the call is established, each device independently initiates verification by submitting its transaction and retrieving the counterpart's. Upon locating a matching transaction from the expected wallet address, the device confirms the other party's identity. As an additional integrity measure, the embedded digest may be compared to a locally computed value for additional session integrity validation. This comparison is not required for identity verification, but reinforces that both parties derived consistent session context. The process is asynchronous, tamper-evident, and privacy-preserving—no raw metadata is exposed on-chain. Devices poll the ledger autonomously, without centralized servers or intermediaries.

Verification occurs only after the session is fully established and relevant metadata is available. It does not delay or interfere with call setup, ensuring the distributed ledger transaction corresponds to an active, negotiated session.

The system enables cryptographically verifiable, bidirectional identity authentication without relying on caller ID, centralized databases, or trusted telephony infrastructure. It functions even in environments with malicious or compromised infrastructure, as long as mutually observed session metadata is exchanged. The system is resilient to spoofing, censorship-resistant, and scalable across diverse calling environments.

Unlike traditional call verification systems, the present invention performs mutual identity validation post-session-setup using independently verifiable, cryptographically signed transactions published to a public distributed ledger. This architecture ensures secure, real-time authentication with strong privacy guarantees and minimal system overhead.

### BRIEF DESCRIPTION OF THE SEVERAL VIEWS OF THE DRAWINGS

FIG. 1 is a high-level block diagram illustrating a computing environment for call verification via distributed ledger transactions, according to one embodiment.

FIG. 2 is a sequence diagram illustrating the relationship between party device, digital identity, wallet address and key pair, according to one embodiment.

FIG. 3 is a high-level block diagram illustrating a detailed view of the calling party device modules shown in FIG. 1, according to one embodiment.

FIG. 4 is a high-level block diagram illustrating a detailed view of the recipient party device modules shown in FIG. 1, according to one embodiment.

FIG. 5 is a sequence diagram illustrating the identity verification process between the calling and recipient party devices during a packet-switched call, corresponding to the interaction of components depicted in FIG. 1, according to one embodiment.

### DETAILED DESCRIPTION OF THE INVENTION

The following description, together with the accompanying drawings, illustrates various exemplary embodiments of the invention and is provided for purposes of explanation, not limitation. Those skilled in the art will appreciate that alternative implementations, configurations, and extensions may be made without departing from the scope and principles disclosed herein. Wherever appropriate, similar reference numbers are used throughout the figures to denote components having like functionality or structure.

The present invention provides a system and method for decentralized, bidirectional identity verification between two parties engaged in a packet-switched voice call—such as one initiated over VoIP or IMS-based infrastructure—after successful session establishment and exchange of call-specific metadata, including Session Description Protocol (SDP) data or encryption keys. Unlike prior telephony authentication systems—such as those relying on centralized identity providers, pre-call assertions, or unidirectional verification—the present invention enables each party to independently verify the other's identity after the session is fully negotiated, using signed, directed transactions submitted to a distributed ledger.

The system does not require real-time trust coordination, manual signature validation, or retrieval of public keys from centralized stores. Identity verification is based solely on the existence of valid, directed transactions accepted by a public distributed ledger, enabling trustless resolution using only session metadata and identity-to-wallet associations that are pre-established through decentralized resolution mechanisms (e.g., DIDs or blockchain-based naming systems).

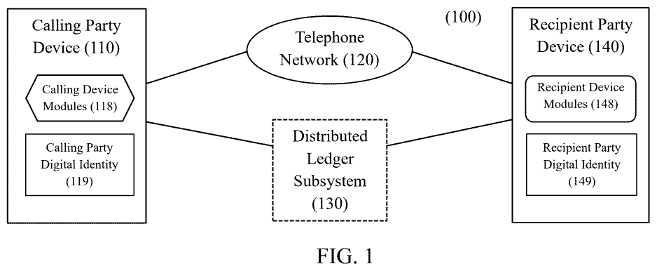

FIG. 1 illustrates a high-level system architecture (100) for decentralized identity verification during packet-switched telephony calls via distributed ledger transactions, according to one embodiment. The system comprises a calling party device (110), a recipient party device (140), a telephone network (120), and a distributed ledger subsystem (130). Each device (110, 140) independently interacts with the distributed ledger subsystem (130) after the call is established, performing cryptographic operations required for identity assertion and verification.

The calling party device (110) and the recipient party device (140) are networked computing systems capable of participating in telephony sessions and performing cryptographic operations. In one embodiment, such devices may include smartphones, VoIP endpoints, SIP clients, embedded modules in IoT systems, enterprise gateways, or any other communication-capable computing systems.

In the embodiment shown in FIG. 1, the calling party device (110) is configured to initiate outbound call sessions, while the recipient party device (140) is configured to receive inbound calls. In alternative embodiments, a device may support only one of these roles or be capable of both initiating and receiving calls, with role selection determined dynamically at runtime or by policy.

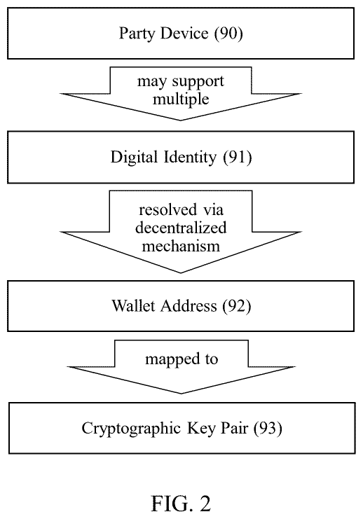

For simplicity, FIG. 1 depicts a single calling device (110) and a single recipient device (140), each supporting one digital identity (119, 149). However, this configuration is illustrative and not limiting. Devices may support multiple digital identities and may dynamically alternate between calling and receiving roles across sessions. The structure and resolution of digital identities are further described in FIG. 2, including their association with wallet addresses and cryptographic key pairs. The architecture supports flexible deployment topologies involving any number of devices participating in identity verification.

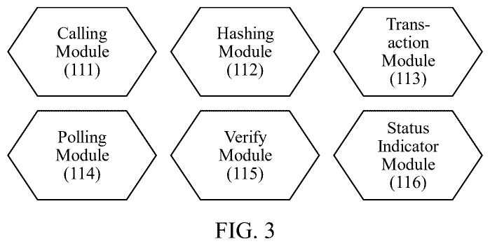

Each device (110, 140) includes internal components responsible for communication handling, identity resolution, transaction generation, and interaction with the distributed ledger subsystem (130). In this embodiment, these components are summarized in FIG. 1 as calling device modules (118) and recipient device modules (148), respectively. Their internal structure is described in further detail in FIGS. 2 and 3.

The calling party device (110) and recipient party device (140) are connected via the telephone network (120) for real-time communication. The telephone network (120) facilitates call signaling and session metadata exchange between the two devices (110, 140) using standard session-based protocols, such as SIP or WebRTC, or any other signaling mechanism that supports the exchange of SDP data. This session metadata includes parameters such as IP addresses, media ports, codecs, and session identifiers, which are used by each device (110, 140) as input to generate cryptographic digests for identity verification. In the embodiment shown in FIG. 1, the telephone network (120) uses the recipient party's digital identity (149) to route the call to the appropriate endpoint.

In this embodiment, the telephone network does not influence or directly participate in the cryptographic verification process and remains agnostic to the cryptographic operations performed by the devices (110, 140). Its sole function is to provide the transport and signaling environment necessary for session establishment. For the purposes of this invention, any communication infrastructure capable of delivering SDP-compliant metadata between parties may fulfill the role of the telephone network.

The distributed ledger subsystem (130) serves as a decentralized and tamper-resistant medium for publishing and retrieving signed verification transactions. These transactions include cryptographic digests of selected session metadata and are signed by the private keys associated with the wallet address of the transaction initiator. Because each wallet address is pre-associated with a digital identity through decentralized resolution, a valid, signed transaction functions as a cryptographic proof of identity. The ledger (130) is not used for real-time communication but provides a shared, immutable context for verification.

Each device (110, 140) independently interacts with the distributed ledger subsystem (130) to perform identity verification operations, either by submitting its own transaction or retrieving the counterpart's transaction once available. The order of operations is implementation-dependent and does not affect correctness—verification can proceed as soon as a valid counterpart transaction is located. The subsystem may be implemented using blockchain networks, DAG-based ledgers, or other decentralized data structures that support public auditability and distributed trust.

FIG. 2 illustrates the internal identity mapping structure maintained by each party device (90), according to one embodiment. This sequence diagram shows how a selected digital identity (91) is mapped to a corresponding wallet address (92) and an associated cryptographic key pair (93). These mappings are established prior to any call session and form the foundation for the trustless identity resolution process used throughout the system.

Each device (90), supports one or more digital identities (91), such as telephone numbers, email addresses, decentralized identifiers (DIDs), or other resolvable identifiers used in telephony signaling. These digital identities are locally managed and pre-associated with wallet addresses (92) and cryptographic key pairs (93) via decentralized and publicly accessible resolution systems, such as blockchain-based naming services (e.g., ENS) or DID registries. The resolution process is implementation-dependent but must not rely on centralized storage or authority. All associations are established before any session begins and remain static throughout the session.

Identity resolution is performed independently by each device and does not require any centralized lookup or negotiation at call time. When provided with the counterpart's digital identity, each device can resolve the corresponding wallet address as needed.

Each wallet address (92) corresponds to a cryptographic key pair (93), comprising a public key and a private key. The private key is used by the device (90) to sign verification transactions submitted to the distributed ledger subsystem (130), and remains securely stored on the device—e.g., within a secure enclave or isolated key store. The storage and access method is implementation-dependent, and private key access may be on-demand or pre-initialized. In all cases, the private key is never exposed externally.

The public key itself does not need to be retrieved or processed by the counterpart device, as the distributed ledger (130) enforces signature validity before accepting a transaction. This makes manual signature verification redundant and unnecessary for this invention's operation.

Each party device (110, 140) in the system, as shown in FIG. 1, is an instance of the generic device (90) shown in FIG. 2. In the architecture, the calling party device (110) and recipient party device (140) represent two such instances participating in an active telephony session.

In any given session, the calling party device (110) selects a single digital identity from its available set to act on behalf of. This selection occurs prior to call establishment and is used both to initiate signaling over the telephone network (120) and to sign the verification transaction submitted to the distributed ledger subsystem (130). The selection may be user-driven (e.g., selected from a UI), programmatic (e.g., based on contact or policy rules), or pre-configured. Only one digital identity is selected and used per call session to represent the calling party (110), even if a device supports multiple.

The calling party device (110) also selects the digital identity of the intended recipient—that is, the addressable identifier to which the call is directed. This identity is used as the routing address for the telephony session and determines which recipient device receives the call, as it determines how the call is routed within the telephony network (120). The recipient party device (140) acts on behalf of the digital identity to which the calling party (110) addressed the call, and does not perform identity selection during the session.

In this context, the digital identities selected by the calling and recipient devices are logically represented in FIG. 1 as components (119) and (149), respectively. These components correspond directly to digital identity (91) in FIG. 2. That is, (119) and (149) are runtime instantiations of (91) in their respective roles during an active session, bound to their respective wallet addresses (92) and cryptographic key pairs (93), in accordance with the mappings shown in FIG. 2.

Each device (90) is already aware of its own digital identity (91) at the time of the call. However, to verify the identity of its counterpart, a device relies on the identity information received through telephony signaling. Specifically, the recipient device (140) treats the “From” field in the signaling message as the asserted identity of the caller and uses it as input for identity resolution and verification. In the context of the architecture illustrated in FIG. 1, this asserted identity corresponds to the caller's selected identity, shown as component (119).

Conversely, the calling party device (110) derives the recipient's identity from the “To” field or from session metadata—such as SDP content—received after the call has been successfully established. This identity reflects the endpoint that answered the call and corresponds to the digital identity the recipient device (140) is acting on behalf of during the session, shown in the system architecture of FIG. 1 as component (149).

These identifiers, though selected prior to call establishment, are conveyed via the signaling exchange, and serve as the basis for post-setup identity verification. This separation between identity signaling and verification timing ensures that no identity is verified before the session is established, while still relying on pre-established mappings.

This identity resolution pathway—Digital Identity→Wallet Address→Key Pair—is evaluated locally by each device. Because all mappings are pre-established and verifiable through decentralized infrastructure, identity verification can proceed without reliance on centralized servers. This design enables each device to independently resolve and authenticate the identity of its counterpart after call establishment.

FIG. 3 illustrates, according to one embodiment, the internal architecture of the calling party device (110). In alternative embodiments, the described functions may be organized differently or implemented in combined components, without departing from the scope of the invention. The internal modules shown in FIG. 3 represent functional groupings that may be implemented as distinct software services, hardware components, or logical units. Naming conventions, modular boundaries, and internal structure are implementation-dependent and may vary across device platforms, provided the described functionality is preserved. As shown in FIG. 3, the calling party device (110) includes internal modules—collectively represented in FIG. 1 as (118)—that perform the following functions:

A calling module (111) for initiating call sessions and managing interactions with the telephony network (120). In one embodiment, this includes constructing and sending session signaling messages and capturing relevant metadata—such as SDP fields—that are exchanged as part of the session negotiation process.

The calling module (111) defers all processing of this metadata until the call has been successfully established. Once establishment is complete, the module parses the received signaling content to extract session-specific information needed for downstream verification tasks. This includes identifying the recipient's asserted digital identity—for example, from the “To” field or from finalized SDP metadata.

While the calling module (111) does not directly perform cryptographic operations, it acts as the entry point for the verification process by obtaining and forwarding all metadata necessary for digest creation and transaction generation. The calling module (111) does not store or expose raw session metadata outside the device and interfaces with the hashing module (112) to supply SDP/session data.

A hashing module (112) for generating cryptographic digests of selected session metadata. In one embodiment, this involves applying a deterministic hash function, such as SHA-256, to a predefined and agreed-upon subset of call-specific data exchanged as part of the session negotiation process. This may include, but is not limited to, SDP fields, negotiated encryption keys, or any mutually known metadata specific to the active session. The selection and ordering of fields to be hashed is standardized across devices (110, 140) through system-level configuration, ensuring that both parties independently compute identical digests from equivalent data inputs.

In alternative embodiments, the digest may be generated using a different deterministic cryptographic digest algorithm, including encrypted or keyed digests, message authentication codes (MACs), or other cryptographic commitments. These alternatives are permitted so long as they guarantee digest consistency between devices operating on shared metadata, thereby maintaining interoperability and verification integrity.

The resulting digest serves as a compact, privacy-preserving representation of session-specific context that can be independently verified without exposing raw metadata. While this digest is embedded in the transaction, its role is to facilitate optional session integrity validation. It does not serve as the basis for identity verification, which is independently confirmed by the ledger's enforcement of valid signatures and addressing.

The hashing module (112) does not store the input metadata or the resulting hash beyond the duration necessary for transaction generation. It interfaces with the calling module (111) to receive session data and with the transaction module (113) to supply the computed digest and metadata necessary for transaction generation.

A transaction module (113) for preparing, signing, and submitting verification transactions to the distributed ledger subsystem (130). In one embodiment, the transaction module (113) is also responsible for resolving both the asserted recipient identity (149) and the caller's own identity (119) to their corresponding wallet addresses. This resolution is performed locally via decentralized mechanisms such as blockchain-based naming systems or DID registries, without requiring real-time negotiation or centralized lookups.

In one embodiment, the transaction module (113) constructs a directed transaction that includes: (i) the cryptographic digest generated by the hashing module (112), and (ii) addressing metadata based on the resolved wallet addresses of both the caller and recipient. The transaction is cryptographically signed on-device using the private key associated with the caller's selected digital identity (119), ensuring authenticity and tamper-resistance. Unlike certificate-based or STIR/SHAKEN-like schemes, no out-of-band signature validation is required; identity is proven solely by the presence of a ledger-validated transaction from a pre-resolved wallet address. Signing occurs entirely within the device; no private key material is ever exposed or transmitted externally.

Once signed, the transaction is submitted to the distributed ledger (130), where it becomes part of the public, immutable record. The transaction module (113) interfaces with the hashing module (112) for digest and metadata input and with local identity resolution components to obtain wallet address mappings. It also supplies transaction-related data (e.g., digest, resolved wallet addresses) to the polling module (114) for use in locating and verifying the counterpart's transaction.

In blockchain-based implementations, submission may incur a transaction fee (“gas”), which must be paid by the sender's wallet. The presence or absence of fees depends on the distributed ledger architecture and does not affect the functional operation of the invention.

A polling module (114) for monitoring the distributed ledger subsystem (130) to detect and retrieve verification transactions posted by the counterpart device (140). In one embodiment, the polling module (114) operates asynchronously, querying the ledger (130) for transactions sent from the wallet address resolved from the claimed digital identity of the recipient to that of the caller. Upon locating a matching transaction, it extracts relevant components, such as the embedded digest, for further verification.

In alternative embodiments, the selection of a verification transaction may be based on implementation-specific filters. These may include, but are not limited to, transaction timestamps or a match between the embedded digest and the locally computed digest of mutually known session-specific metadata, such as SDP fields, negotiated encryption keys, or other agreed-upon call parameters. This ensures precision in environments where multiple transactions may be present.

The polling module (114) operates independently of the telephony signaling system (120) and does not initiate or rely on call signaling flows. It interfaces with the transaction module (113) to coordinate polling triggers and with the verify module (115) to pass retrieved transaction data for validation, along with associated session metadata and resolved wallet addresses, as received from earlier transaction preparation.

Polling is only triggered after the session has been successfully established—such as after the receipt of a session acceptance message (e.g., SIP “200 OK”) or the completion of SDP negotiation. In alternative embodiments, caller-side polling and transaction submission may occur concurrently or in a different order, provided all operations remain locally triggered and fully decentralized. In alternative embodiments, polling may be triggered independently of the transaction module (113), e.g. by system-defined post-establishment events, timers, or internal state transitions. All triggers must be local and decentralized, maintaining the trustless and asynchronous architecture of the system, without reliance on centralized services.

A verify module (115) for validating the authenticity and integrity of a verification transaction retrieved from the distributed ledger subsystem (130). In one embodiment, the verify module (115) performs a local integrity check by comparing the digest embedded in the counterpart's transaction with a locally computed digest of mutually known session metadata—such as SDP fields, encryption keys, or any other agreed-upon session-specific data. A successful match confirms that both parties (110, 140) observed consistent session context, while a mismatch may indicate tampering or configuration discrepancies.

The digest comparison step enhances session context validation but is not required to establish identity, which is guaranteed by the ledger-verified signature and wallet address mapping. The digest comparison step confirms session alignment, but the presence of the valid, signed transaction itself constitutes the core of identity verification, as it cryptographically proves control over the associated private key.

Signature validation is not performed by this module, as the distributed ledger (130) enforces signature integrity before accepting any transaction. The mere presence of a valid, directed transaction on the ledger (130) thus constitutes cryptographic proof of identity—based on the transaction sender's control over the private key associated with the resolved wallet address. The digest check is an additional, privacy-preserving safeguard that ensures session metadata consistency but is not strictly required for identity verification.

The verify module (115) interfaces with the polling module (114) to receive retrieved transaction data and to obtain the locally computed digest, session metadata, and resolved wallet address mappings—each of which may have been passed from the transaction module (113) as part of the earlier transaction preparation workflow. In alternative embodiments, this input data may be retrieved or reconstructed via other implementation-specific mechanisms, provided they operate within the decentralized and trustless framework defined by the invention and do not rely on centralized intermediaries or runtime coordination between parties.

The verify module (115) may also interface with a status indicator module (116), to supply the verification outcome. The verify module (115) does not access private key material and performs no signing operations.

A status indicator module (116) for providing real-time feedback on the outcome of the identity verification process. In the default embodiment, this module is triggered only upon completion of the verification workflow—specifically after the verify module (115) confirms that the locally computed digest matches the digest embedded in the counterpart's transaction. Upon successful verification, the module may present a confirmation indicator to the user or system. In cases of verification failure (e.g., digest mismatch), it may indicate the failure and optionally trigger downstream responses such as warnings, logs, or session termination.

In alternative embodiments, the status indicator module (116) may also provide intermediate updates during the verification process. For example, indicators may be triggered when polling begins, when a transaction is discovered or not discovered, or while verification is pending. These updates may take the form of visual (e.g., icons, colors, text messages), auditory (e.g., tones, speech cues), haptic (e.g., vibrations), or programmatic outputs (e.g., log entries or API callbacks).

The module's behavior, delivery format, and timing are implementation-dependent and may be customized based on user preferences, device capabilities, or system policies. The status indicator module (116) does not perform verification itself, but operates based on inputs from other modules, such as the verify module (115). Its role is to enhance transparency and user trust by clearly signaling the verification status of the counterpart's identity.

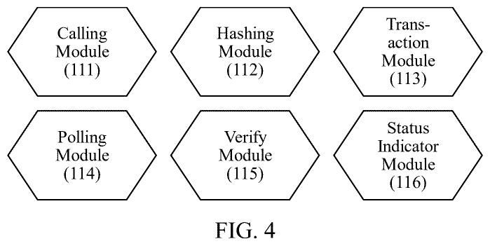

FIG. 4 illustrates, according to one embodiment, the internal architecture of the recipient party device (140). While the device architecture supports similar modular functions as the calling party device (110), its configuration emphasizes reactive roles—receiving inbound calls, performing counterpart identity verification, and responding to the verification outcome.

In alternative embodiments, the described modules may be organized differently or implemented as composite components without departing from the scope of the invention. The module groupings shown in FIG. 4 are functional abstractions that may correspond to software services, hardware elements, or logical units, depending on platform constraints. Module boundaries, naming, and implementation specifics are non-limiting and may vary.

As shown in FIG. 4, the recipient party device (140) includes internal modules—collectively represented in FIG. 1 as (148)—that perform the following operations:

A receiving module (141) for handling inbound telephony signaling messages via the telephone network (120) and extracting session metadata. In one embodiment, the module listens for signaling messages such as SIP “200 OK” or equivalent session acceptance indicators, confirming that the recipient device (140) has answered the call and session negotiation is complete. Only upon this confirmation does the module parse the received signaling data—including SDP fields, caller identity, and other session parameters—and supply the resulting metadata to downstream components for verification. This includes forwarding relevant information to the polling module (142), which may trigger the start of the asynchronous identity verification workflow.

The receiving module (141) acts as the initial entry point for finalized session data and ensures that no identity resolution or verification is performed prematurely. It interfaces with the polling module (142) to coordinate trigger conditions and to supply session metadata needed for digest validation/computation and transaction discovery/creation. In alternative embodiments, the specific trigger conditions for data extraction may vary by signaling protocol or system design, but must always respect the requirement that verification begins only after successful session establishment.

A polling module (142) for monitoring the distributed ledger subsystem (130) to detect and retrieve verification transactions submitted by the calling party device (110). This module serves the same general function as polling module (114)—that is, identifying counterpart transactions on the ledger for verification—but is adapted for use on the recipient-side device (140) and triggered under a different control flow.

In one embodiment, the polling module (142) resolves both the asserted caller identity (119) and the recipient's own identity (149) to their corresponding wallet addresses using decentralized identity resolution mechanisms, such as blockchain-based naming systems or DID registries. With these wallet addresses, it queries the ledger (130) for transactions addressed to the recipient and originating from the caller. Once a candidate transaction is found, the module extracts relevant elements—such as the embedded digest—for downstream verification.

As with module (114), polling is only triggered after the session has been successfully established, e.g., after receipt of a SIP “200 OK” or completion of session metadata negotiation. However, in this embodiment, the polling trigger originates from the receiving module (141), which monitors signaling flows and session readiness. The polling module (142) then passes the retrieved transaction, resolved wallet addresses and the associated session metadata, which was supplied via the receiving module (141), to the verify module (143).

In alternative embodiments, recipient-side polling and transaction submission may occur concurrently or in a different order, as long as all operations are locally triggered and fully decentralized. The polling trigger does not have to originate from the receiving module (141); it may instead be initiated by system-defined events, internal timers, or call state transitions. Additionally, transaction selection may involve implementation-specific filters, such as digest matching, timestamp validation, or other session parameters. Regardless of these variations, all behavior remains autonomous and trustless, requiring no centralized coordination or runtime negotiation between devices.

This module does not initiate or rely on telephony signaling and performs all identity lookups and ledger queries autonomously. It acts as an information bridge, coordinating between the receiving module (141) and the verify module (143) in a trustless, asynchronous manner.

A verify module (143) for validating the authenticity and integrity of a verification transaction retrieved from the distributed ledger subsystem (130). This module (verify module 143 in FIG. 4) is functionally equivalent to the verify module (115) in FIG. 3, and performs the same core tasks of digest comparison and identity confirmation, based on mutually known session metadata—such as SDP fields, encryption keys, or other agreed-upon parameters. As with module (115), signature validation is not required, as signature integrity is enforced by the distributed ledger subsystem (130), and the presence of a valid transaction constitutes sufficient proof of private key control.

In contrast to verify module (115), which receives a precomputed digest, module (143) initiates local digest computation by interfacing with the hashing module (144), to which it forwards the session metadata received from the polling module (142). Upon receiving the computed digest, it compares it with the digest embedded in the ledger transaction, also received from the polling module (142), to confirm session context consistency.

Upon successful verification, the module triggers the creation of a reciprocal verification transaction by passing the computed digest, resolved wallet addresses, and relevant context to the transaction module (145). The verify module (143) may also interface with a status indicator module (146) to propagate the verification outcome to users or system components.

In alternative embodiments, verify module (143) may be triggered by the hashing module (144) or another event-driven subsystem, and its execution flow may vary depending on implementation details, as long as it operates post-call establishment and within the decentralized model of the invention. The module performs no signing operations and has no access to private key material.

A hashing module (144) for generating cryptographic digests of selected session metadata. This module performs the same core functionality as the hashing module (112), as described previously, and applies a deterministic hash function (e.g., SHA-256) to a predefined and agreed-upon subset of session-specific metadata—such as SDP fields, negotiated encryption keys, or other mutually known call parameters exchanged during session setup. The selection and ordering of fields to be hashed is standardized across devices to ensure consistency and interoperability.

Unlike hashing module (112), which interfaces with the calling module (111), the hashing module (144) receives session metadata from the verify module (143), which also initiates the digest computation process. Upon completing the digest computation, the module returns the resulting digest to the verify module (143) for further validation and transaction coordination. It does not interface directly with the transaction module (145), and it retains no state beyond the duration of digest computation.

In alternative embodiments, the hashing function may be replaced with other deterministic cryptographic constructions—such as keyed digests, encrypted commitments, or message authentication codes (MACs)—provided that both parties can independently compute matching digests from equivalent input data. These alternatives are acceptable as long as they maintain the system's trustless and interoperable properties.

A transaction module (145) for preparing, signing, and submitting a verification transaction to the distributed ledger subsystem (130), functionally analogous to transaction module (113) in FIG. 3. It performs the same core operations—constructing a directed transaction that includes a cryptographic digest and resolved wallet addresses, signing it using a locally held private key, and submitting it to the ledger (130). However, in this embodiment, the module receives its inputs—including the computed digest, session metadata, and resolved wallet addresses—from the verify module (143), rather than interfacing directly with a hashing module.

The transaction is signed using the private key associated with the recipient's selected digital identity (149), and is addressed to the caller's resolved wallet address. All signing operations are performed securely on-device, ensuring that private key material is never exposed externally. Once signed, the transaction is submitted to the distributed ledger (130), making it discoverable by the calling device (110).

In contrast to transaction module (113), this module does not interface with the polling module and is instead triggered by the verify module (143) after the locally computed digest is successfully matched against the digest embedded in the counterpart's verification transaction. In alternative embodiments, the transaction module (145) may also be invoked directly by the hashing module (144) or another system-defined event following call establishment and verification.

A status indicator module (146) for providing real-time feedback on the outcome of the identity verification process, functionally equivalent to the status indicator module (116) in FIG. 3, which was described above for the calling party device (110). In the default embodiment, the status indicator module (146) is triggered by the verify module (143) upon completion of the verification workflow—specifically after the computed digest of session metadata is successfully matched against the digest embedded in the counterpart's transaction.

Upon success, the module may present a confirmation indicator to the user or system; upon failure (e.g., digest inconsistency), it may trigger alerts, logs, or other application-Defined responses.

As with module (116), alternative embodiments may support intermediate feedback during the verification lifecycle, including status indicators triggered during polling, transaction discovery, or digest computation. Supported outputs may include visual, auditory, haptic, or programmatic indicators, with behavior customizable according to device capabilities or user/system policies.

The status indicator module (146) does not itself perform cryptographic verification, but operates based on inputs received from the verify module (143) and potentially other modules depending on the implementation.

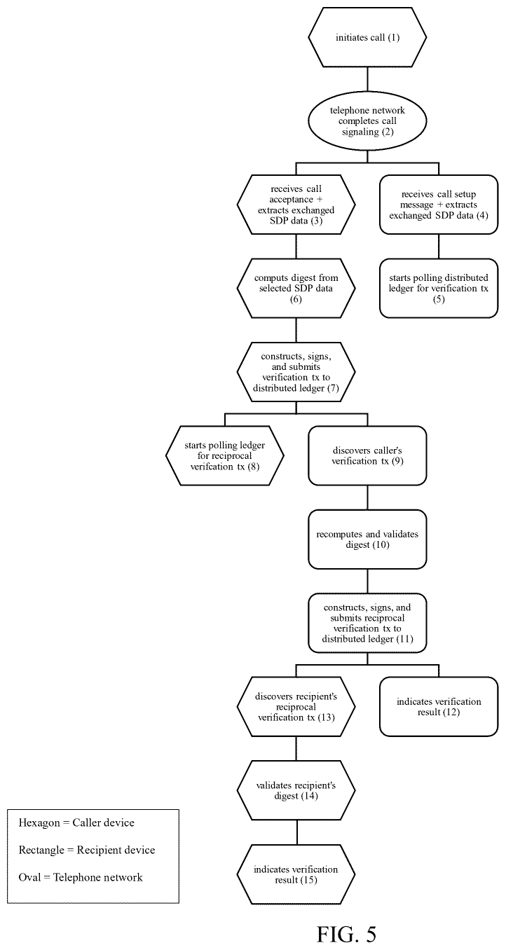

FIG. 5 illustrates the sequence of operations for the decentralized, bidirectional identity verification process between a calling party device (110) and a recipient party device (140) during a packet-switched voice call, according to one embodiment. In alternative embodiments, the sequence may vary in execution order, concurrency, or module interaction, without departing from the scope of the invention.

The process shown in FIG. 5 is executed autonomously by each party device (110, 140)—meaning that each device initiates and performs its own verification steps without requiring runtime coordination or centralized control. While each device may independently submits its own verification transaction and may begin polling after session establishment, the actual verification of the counterpart's identity remains dependent on the availability of that counterpart's signed transaction. This architecture preserves a trustless and asynchronous model while accommodating the natural dependency on counterpart data for final verification.

In step 1, the calling module (111) on the calling party device (110) initiates a call request via the telephone network (120). The calling device (110) selects a digital identity (119) to represent itself and designates a target digital identity (149) as the recipient. These identities are encoded into the session signaling metadata—typically in the “From” and “To” fields—which is transmitted as part of the call setup request.

In step 2, the telephone network (120) completes the signaling exchange, and both the calling party device (110) and the recipient party device (140) receive the finalized session signaling metadata, including SDP data. The receipt of this data marks the point of successful session establishment and defines the starting point for the decentralized identity verification process. The receipt of this metadata serves as the trigger for the calling module (111) on the calling party device (110) and the receiving module (141) on the recipient party device (140) to begin identity verification processing.

Steps 3 and 4 occur concurrently and independently on the respective devices, each triggered by the receipt of the finalized session signaling metadata in step 2.

In step 3, the calling module (111) on the calling party device (110) processes the finalized session signaling metadata received in step 2, including the recipient's asserted digital identity (149) and other session-specific parameters. The module parses this metadata to extract values relevant to identity verification, such as those found in the “To” field and SDP attributes. The extracted information forms the basis for verifying the recipient's claimed identity and is forwarded to the hashing module (112) for further processing.

In step 4, the receiving module (141) on the recipient party device (140) processes the finalized session signaling metadata received in step 2, including the caller's asserted digital identity (119) and associated session parameters. The module parses this metadata to extract values relevant for verifying the caller's claimed identity and forwards the resulting information to the polling module (142) for further processing.

In step 5, the polling module (142) on the recipient party device (140) is triggered by the metadata extracted and forwarded in step 4. The module performs decentralized identity resolution to convert the asserted digital identities of both the caller (119) and recipient (149) into corresponding wallet addresses, using blockchain-based naming systems, decentralized identifiers (DIDs), or other resolution mechanisms.

Using these resolved addresses, the polling module initiates asynchronous queries to the distributed ledger subsystem (130), searching for a verification transaction originating from the caller's wallet address and directed to the recipient's wallet address. The polling module expects the located transaction to contain a cryptographic digest.

This polling process is performed autonomously and proceeds regardless of whether a matching transaction has already been posted. The polling continues asynchronously until a matching verification transaction is discovered or a timeout condition is met, as further described in step 9.

In step 6, the hashing module (112) on the calling party device (110) is triggered by the session metadata extracted in step 3. The module computes a deterministic cryptographic digest over the selected session-specific parameters using a standardized hashing algorithm. The resulting digest, along with the original session metadata used in the computation, is forwarded to the transaction module (113) for further processing.

In step 7, the transaction module (113) on the calling party device (110) is triggered by the digest and session metadata received from the hashing module (112) in step 6. The module performs decentralized identity resolution to convert the digital identities of both the caller (119) and the recipient (149) into their corresponding wallet addresses.

Using the resolved addresses, the module constructs a directed verification transaction that includes the computed digest, sender and recipient wallet addresses, and a digital signature derived from the caller's private key. This transaction is signed locally and submitted to the distributed ledger subsystem (130), where it becomes publicly accessible. The ledger enforces signature and format validity at submission.

The same resolved wallet addresses and computed digest are also passed to the polling module (114) to initiate the caller's polling sequence in step 8. The transaction submitted in this step (step 7) is the object of the recipient's discovery process described in step 9.

In step 8, the polling module (114) on the calling party device (110) is triggered by the resolved wallet addresses and computed digest received from the transaction module (113) in step 7. The module initiates asynchronous queries to the distributed ledger subsystem (130), searching for a reciprocal verification transaction originating from the wallet address associated with the recipient's claimed digital identity (149) and directed to the caller's own wallet address, resolved from the caller's selected digital identity (119). The polling module expects the located transaction to contain a cryptographic digest in the metadata.

The polling process continues autonomously and independently until a matching transaction is discovered or a timeout condition is met, as further described in step 13. This decentralized polling and identity retrieval contrasts with prior art systems that rely on synchronized identity lookups or centralized key resolution authorities.

In step 9, the polling module (142) on the recipient party device (140) discovers the verification transaction submitted by the calling party device (110) in step 7. This discovery occurs as part of the asynchronous polling process initiated in step 5.

The polling module (142) detects a transaction that originates from the wallet address resolved from the caller's claimed digital identity (119) and is directed to the wallet address associated with the recipient's identity (149). Upon locating the transaction, the polling module (142) retrieves the embedded payload, including the cryptographic digest.

This information is passed to the verify module (143), along with the session metadata previously extracted in step 4 and retained through the polling process. The verify module (143) is thereby triggered to begin validation, as described in step 10.

In step 10, the verify module (143) on the recipient party device (140) is triggered by the cryptographic digest retrieved in step 9, along with the corresponding session metadata extracted in step 4. The module requests the hashing module (144) to recompute a digest over the received session parameters using the same deterministic algorithm employed in step 6.

Upon receiving the recomputed digest, the verify module (143) compares it to the digest embedded in the caller's verification transaction. The result of this comparison—whether successful or not—is transmitted to the status indicator module (146) to initiate user or system feedback in step 12.

If the digests match, the verification is considered successful, indicating that both devices independently derived consistent session metadata. In this case—as depicted in the flow of FIG. 5—the verify module (143) forwards the validated digest and the resolved wallet addresses to the transaction module (145) to initiate reciprocal transaction submission in step 11.

Importantly, the caller's identity itself is cryptographically established through the existence of the valid transaction on the distributed ledger subsystem (130), as ledger acceptance requires a valid digital signature tied to the resolved wallet address. The digest comparison serves solely to confirm session alignment between both parties.

Depending on implementation, the verify module (143) may also trigger the transaction module even if the digests do not match—for example, to allow the counterpart an opportunity to complete its own verification independently. Digital signature verification is omitted at this stage, as transaction integrity is enforced by the distributed ledger subsystem (130) at submission, meaning that the presence of the valid transaction itself serves as cryptographic proof of control over the corresponding private key associated with the resolved wallet address.

In step 11, the transaction module (145) on the recipient party device (140) is triggered by the validated digest and resolved wallet addresses received from the verify module (143) in step 10.

Using this data, the module constructs a directed verification transaction that includes the recipient's computed digest and addressing metadata. The recipient's wallet address—corresponding to digital identity (149)—is set as the sender, and the caller's wallet address—corresponding to identity (119)—is designated as the recipient.

The transaction is cryptographically signed using the recipient's private key, with all signing operations performed locally and securely on the recipient device (140). Once signed, the transaction is submitted to the distributed ledger subsystem (130), where it becomes publicly accessible.

The ledger enforces transaction format and signature validity upon submission, ensuring only authentic, tamper-resistant transactions are accepted. This step (step 11) finalizes the recipient-side identity assertion process and enables the calling party device (110) to perform reciprocal verification, as described in step 13.

In step 12, the status indicator module (146) on the recipient party device (140) is triggered by the verification result produced by the verify module (143) in step 10. The module receives this result—whether indicating a successful or failed digest comparison—and presents it to the user or to downstream system components.

The presentation format may vary depending on implementation and device capabilities, and may include visual indicators (e.g., icons or banners), auditory signals (e.g., tones or spoken output), haptic cues (e.g., vibration patterns), or programmatic interfaces (e.g., API events or logging). This output provides real-time confirmation of the verification outcome and supports human or system decision-making based on the result.

This operation (step 12) is logically independent of the transaction submission process in step 11 and may proceed in parallel or under different timing constraints, depending on system configuration. The separation of status indication from ledger interaction enables responsive and modular behavior within the overall architecture.

In step 13, the polling module (114) on the calling party device (110) discovers the reciprocal verification transaction submitted by the recipient party device (140) in step 11. This transaction is detected during the ongoing polling process initiated in step 8, based on resolved wallet addresses associated with each party.

Upon detecting the transaction—originating from the wallet address resolved from the claimed digital identity of the recipient (149) and directed to the caller's wallet address (119)—the polling module retrieves its payload, including the embedded cryptographic digest. This data is passed to the verify module (115), along with the session metadata originally extracted in step 3 and the caller's own computed digest, originally generated when step 6 was triggered.

The verify module (115) is thereby activated to begin the identity verification process in step 14. This polling and validation workflow proceeds without requiring coordination or signaling from the recipient device (140) and is triggered entirely by the availability of the counterpart's transaction on the distributed ledger subsystem (130). The independence of this step ensures full architectural symmetry and supports the system's trustless, bidirectional design.

In step 14, the verify module (115) on the calling party device (110) is triggered by the data received from the polling module (114) in step 13. This includes the cryptographic digest embedded in the recipient's verification transaction, the session metadata originally extracted in step 3, and the caller's own computed digest from step 6.

The verify module (115) compares the locally computed digest with the one embedded in the retrieved transaction to determine whether both parties independently derived the same session-specific values. A successful match—as depicted in the flow of FIG. 5—indicates that the recipient's verification transaction corresponds to the same active session context observed by the caller.

Importantly, the recipient's identity itself is cryptographically established through the existence of the valid transaction on the distributed ledger subsystem (130), as ledger acceptance requires a valid digital signature tied to the resolved wallet address. The digest comparison serves solely to confirm session alignment between both parties.

Regardless of the comparison outcome, the verify module (115) forwards the verification result to the status indicator module (116) to initiate step 15. This step (step 14) finalizes the caller-side identity assertion process.

In step 15, the status indicator module (116) on the calling party device (110) is triggered by the verification result produced by the verify module (115) in step 14. This result reflects whether the session-specific digest from the recipient's verification transaction matches the locally computed digest, thereby confirming or rejecting session alignment.

The status indicator module (116) receives this result and presents it to the user or to downstream system components. Presentation formats may vary based on device configuration and implementation requirements, and may include visual indicators (e.g., icons, banners, or color changes), auditory signals (e.g., tones or spoken messages), haptic feedback (e.g., vibration patterns), or programmatic outputs (e.g., logs, events, or API calls).

This operation is logically independent from prior transaction submission and polling workflows, and is triggered solely by the output of the verify module (115). The separation of result reporting from ledger-bound operations ensures architectural modularity and supports responsive system behavior in both successful and unsuccessful verification scenarios.

The verification process described herein is both trustless and asynchronous. Unlike prior art that depends on caller-centric assertions, centralized key resolution, or real-time verification infrastructure, the present invention enables each party in a packet-switched telephony session to independently verify the counterpart's identity after session setup. Identity is confirmed solely through the existence of a valid, signed transaction published to the distributed ledger by the counterpart. The digest comparison step further ensures both parties independently derived the same session-specific metadata and confirms that the verification transaction corresponds to the specific, active session between the two devices. The only synchronous element in the system is the passive polling phase, in which each party waits for the counterpart's transaction to become available. This architecture supports mutual authentication without runtime coordination, certificate validation, or trusted intermediaries—enabling a fully decentralized, privacy-preserving identity verification system.

The invention claimed is:

1. A system for mutual identity verification during a packet-switched telephone call, comprising:
a first device configured to initiate a telephone call over a packet-switched network to a second device;
a second device configured to receive the telephone call initiated by the first device;
wherein, after the call is established, the first device is further configured to:
generate a cryptographic digest of session-specific metadata associated with the call;
resolve a claimed digital identity of the second device to a corresponding wallet address using a decentralized identity resolution mechanism;
submit a signed, directed transaction to a distributed ledger, the transaction including the digest and being addressed to the wallet address resolved from the claimed digital identity of the second device, and signed using a private key associated with the first device's wallet address;
retrieve a transaction submitted by the second device to the distributed ledger, the transaction being addressed to a wallet address associated with the first device;
compare the digest embedded in the retrieved transaction with a locally computed digest from shared session-specific metadata;
wherein, after the call is established, the second device is similarly configured to:
generate a cryptographic digest of the same session-specific metadata;
resolve the claimed digital identity of the first device to a corresponding wallet address using a decentralized identity resolution mechanism;
submit a signed, directed transaction to a distributed ledger, the transaction including the digest and being addressed to the wallet address resolved from the claimed digital identity of the first device, and signed using a private key associated with the second device's wallet address;
retrieve a transaction submitted by the first device to the distributed ledger, the transaction being addressed to a wallet address associated with the second device;
compare the digest embedded in the retrieved transaction with a locally computed digest from shared session-specific metadata;
wherein:
each device is configured to independently submit a transaction and to initiate polling for a counterpart transaction;
polling is initiated independently of the existence of the counterpart transaction on the distributed ledger;
verification is performed upon discovery of a counterpart transaction on the distributed ledger;
each transaction acts as a cryptographically verifiable identity assertion;
the presence of a signed transaction on the distributed ledger constitutes cryptographic proof that the submitting party controls the private key associated with the resolved wallet address; and
all verification steps occur after call establishment and without reliance on centralized identity servers or telephony metadata.

2. A method for mutual identity verification during a packet-switched telephone call, comprising:
initiating, by a first device, a telephone call to a second device over a packet-switched network;
receiving, by the second device, the telephone call initiated by the first device;
wherein, after the call is established, each device:
generates a cryptographic digest of session-specific metadata associated with the call;
resolves the claimed digital identity of the counterpart device to a corresponding wallet address using a decentralized identity resolution mechanism;
submits a signed, directed transaction to a distributed ledger, the transaction including the digest and being addressed to the wallet address resolved from the claimed digital identity of the counterpart device, and signed using a private key associated with the submitting device's wallet address;
initiates polling for a counterpart transaction submitted by the other device;
retrieves the counterpart transaction upon its availability on the distributed ledger;
compares the digest embedded in the retrieved transaction with the locally computed digest of the same session-specific metadata;
wherein:
the submission and retrieval of transactions are performed independently and asynchronously by each device;
verification is performed only after a counterpart transaction is successfully retrieved from the distributed ledger;
the presence of a signed transaction on the distributed ledger constitutes cryptographic proof that the submitting party controls the private key associated with the resolved wallet address; and
all verification steps occur after the call is established and without reliance on centralized identity servers or telephony metadata.

3. The system or method of claim 1 or 2, wherein the session metadata comprises data exchanged during call setup and is mutually known to both devices, including but not limited to Session Description Protocol (SDP) fields or negotiated encryption keys.

4. The system or method of claim 1 or 2, wherein the selection and ordering of the session-specific metadata fields used for computing the cryptographic digest is pre-agreed upon by both devices.

5. The system or method of claim 1 or 2, wherein the cryptographic digest is generated using a public, deterministic hash function applied to the mutually known session metadata.

6. The system or method of claim 1 or 2, wherein each claimed digital identity is resolvable, via a decentralized and publicly accessible mechanism, to a wallet address that is associated with a cryptographic key pair controlled by the corresponding device.

7. The system or method of claim 1 or 2, wherein the distributed ledger is a decentralized public blockchain or another tamper-resistant, verifiable ledger.

8. The system or method of claim 1 or 2, wherein verification is performed only after the call is established and does not delay or interfere with the call setup process.

9. The system or method of claim 1 or 2, wherein at least one of the devices provides a visual, auditory, haptic, or programmatic indication of identity verification status.

10. The system or method of claim 1 or 2, wherein the presence of a signed, directed transaction on the distributed ledger constitutes the core identity verification, and the digest comparison provides an additional integrity check.

11. The system or method of claim 1 or 2, wherein each device securely accesses a private key associated with its own wallet address, the wallet address being pre-associated with the device's selected digital identity.

12. The system or method of claim 1 or 2, wherein each submitted transaction includes addressing metadata indicating the intended recipient's wallet address resolved from a claimed digital identity.
